(19) United States
(12) Patent Application Publication
(10) Pub. No.: US 2019/0358474 A1
(43) Pub. Date: Nov. 28, 2019

(54) STOP FIRE

(71) Applicant: Humberto Pena, Bronx, NY (US)

(72) Inventor: Humberto Pena, Bronx, NY (US)

(21) Appl. No.: 16/422,961

(22) Filed: May 25, 2019

Related U.S. Application Data
(60) Provisional application No. 62/676,286, filed on May 25, 2018.

(51) Int. Cl. A62C 3/00; A62C 2/04

(52) U.S. Cl. CPC A62C 3/00; A62C 2/04

(57) ABSTRACT

A device for containing a campfire structured and arranged for preventing large, rapidly spreading fires to provide campers and hikers with a more efficient and effective alternative for ensuring a campfire has been extinguished fully.

### CROSS-REFERENCE TO RELATED APPLICATION

The present application is related to and claims priority from prior provisional application Ser. No. 62/676,286, filed May 25, 2018 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

The following includes information that may be useful in understanding the present invention(s). It is not an admission that any of the information provided herein is prior art, or material, to the presently described or claimed inventions, or that any publication or document that is specifically or implicitly referenced is prior art.

The present invention relates generally to the field of campfire devices and more specifically relates to a device for containing a campfire structured and arranged for preventing large, rapidly spreading fires to provide campers and hikers with a more efficient and effective alternative for ensuring a campfire has been extinguished fully.

### 2. Description of the Related Art

During the last several years, the fire seasons have been particularly destructive, affecting an average of more than four million acres of land in 2013, 2014, and 2015 (or more land than the states of Connecticut and Rhode Island combined.) The fires destroyed many newer homes and communities built on the edges of forest land, and the worst may be yet to come in future years. There is growing concern in the insurance industry because of a recent trend toward increased losses from wildfires and floods. Increased exposure reflects population growth, forcing new development adjacent to wild lands and flood prone areas. These factors, coupled with changes in weather patterns and rainfall, have heightened loss potential. The insured loss from 2015's fires in California alone was 2 billion. More than seven million homes in California are in areas categorized in the three highest fire-risk levels. Insurers are also exposed to increasing flood losses for commercial and industrial properties.

Only a few years ago, several large wildfires in southern California dominated media headlines as they encroached on the suburbs surrounding both San Diego and Los Angeles. In total, about 500,000 acres of land (about the size of Rhode Island) were burned. In addition, a total of 3,581 homes, a countless number of vehicles and a number of commercial buildings were destroyed, disrupting hundreds of thousands of people's lives. Given this level of destruction, it is apparent that a real need exists for some type of device or apparatus which could be used to safeguard homes and other structures from the risks of being damaged or destroyed by rapidly spreading brush fires or forest fires.

Unfortunately, the most prevalent causes of forest fires: inattentive campers and hikers. According to the National Fire Service, over 1,000 forest fires in 2015 were caused by campers. Whether incorrectly preparing an area for a camp fire or thoughtlessly leaving burning embers behind, negligence by campers can lead to the loss of thousands of acres of land, not to mention potential property and life loss.

Various attempts have been made to solve problems found in campfire device art. Among these are found in: U.S. Pat. No. 4,363,313 to Robert J. Smith; U.S. Pat. No. 5,329,917 to David C. Young; and U.S. Pat. No. 6,425,387 to John Rohback, Jr. This prior art is representative of camp fire devices for containing a campfire.

Ideally, a device for containing a campfire should be user-friendly and safe in-use and yet would operate reliably and be manufactured at a modest expense. Thus, a need exists for a device for containing a campfire structured and arranged for preventing large, rapidly spreading fires to provide campers and hikers with a more efficient and effective alternative for ensuring a campfire has been extinguished fully and to avoid the above-mentioned problems.

### BRIEF SUMMARY OF THE INVENTION

In view of the foregoing disadvantages inherent in the known campfire device art, the present invention provides a novel Device for Containing A Campfire (Entitled Stop Fire). The general purpose of the present invention, which will be described subsequently in greater detail is to provide a device for containing a campfire structured and arranged for preventing large, rapidly spreading fires to provide campers and hikers with a more efficient and effective alternative for ensuring a campfire has been extinguished fully.

A device for containing a campfire, the device comprising: a body unit having a removable top, a base, three sides that are thirty inches in width, and three sides that are four inches in width; at least one mesh egress point integrated into each side of the body unit and at least one mesh egress point integrated into the removable top; a quenching agent container, wherein the quenching agent container is containable inside the body unit; a quenching agent comprising a mixture of sand and water; and an activation unit. Wherein the body unit is twenty-five inches in height. Wherein the three four inches sides and the three thirty inches sides alternate to form a triangular shape with flat corners. Wherein the quenching agent is contained inside the quenching agent container unit. Wherein the quenching agent is expellable from the quenching agent container through the mesh egress points in the body unit to quench a campfire. Wherein the activation unit is operably connected to expel the quenching agent from the mesh egress points when activated.

The present invention holds significant improvements and serves as a Device for Containing A Campfire. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Device for Containing A Campfire (Entitled Stop Fire), constructed and operative according to the teachings of the present invention.

FIG. 1 shows a perspective view illustrating a device for containing a campfire according to an embodiment of the present invention.

FIG. 2 is a perspective view illustrating a device for containing a campfire according to an embodiment of the present invention of FIG. 1.

FIG. 3 is a perspective view illustrating device for containing a campfire according to an embodiment of the present invention of FIG. 1.

FIG. 4 is a perspective view illustrating device for containing a campfire according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a campfire device and more particularly to a campfire device art, the present invention provides a novel Device for Containing A Campfire (Entitled Stop Fire) structured and arranged for preventing large, rapidly spreading fires to provide campers and hikers with a more efficient and effective alternative for ensuring a campfire has been extinguished fully.

Generally speaking, the Stop Fire system would provide numerous benefits and advantages over current fire-fighting procedures. Quenching agents concentrated into specially designed boxes that are more easily directed to the source of the fire, this method would allow users to easily and expediently ensure that any fire is out. With this clever, quick acting arsenal, campers would be able to follow correct fire-setting procedures without worry that they will accidentally cause a raging wildfire.

Since the Stop Fire system would contain concentrated quenching agents that can be widely distributed at point of impact, this product could alleviate the waste of agent overuse, the Stop Fire would offer a convenient, accessible means to ensure that any camp fire is completely staunched. The Stop Fire would be comprised of a round or triangular box unit. Featuring mesh egress points over its construction, the box would incorporate a mixture of sand and water as quenching agents to completely smother burning embers and even flames.

As conceived, this product could be included with one's camping equipment or made available in parks for consumer use. Stop Fire would be able to easily and expediently douse a dangerous fire, the Stop Fire system could ensure that damage is prevented or at least kept to a bare minimum, saving millions of dollars in destroyed homes, thousands of acres of needed forest land, and of course, unnecessary loss of life as well as the waste of agents due to prevailing wind gusts.

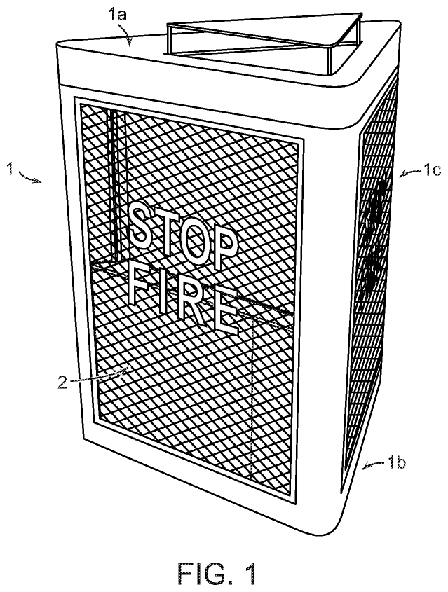

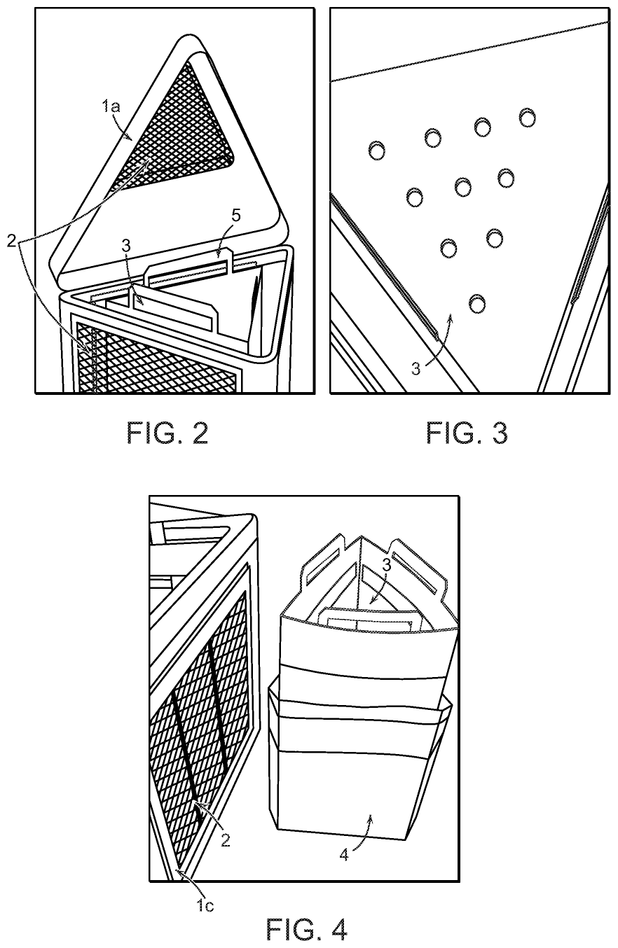

Referring to the drawings by numerals of reference there is shown in FIGS. 1-3 illustrating, perspective views illustrating device for containing a campfire including body unit 1 according to an embodiment of the present invention.

A device for containing a campfire, the device comprising: body unit 1 having removable top 1a, base 1b, three sides 1c that are thirty inches in width, and three sides 1d that are four inches in width; at least one mesh egress point 2 integrated into each side 1c of body unit 1 and at least one mesh egress point 2 integrated into removable top 1a; quenching agent container 3, wherein the quenching agent container is containable inside the body unit; quenching agent 4 comprising a mixture of sand and water; and activation unit 5, wherein activation unit 5 is operably connected to expel quenching agent 4 from the mesh egress points 2 when activated. Wherein body unit 1 has six sides.

Wherein body unit 1 is twenty-five inches in height, and wherein the three four inches sides 1d and the three thirty inches sides 1c alternate to form a triangular shape with flat corners. Wherein quenching agent 4 is contained inside quenching agent container unit 3, and wherein quenching agent 4 is expellable from the quenching agent container 3 through the mesh egress points in the body unit to quench a campfire.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A device for containing a campfire, the device comprising:
(1) a body unit having
(a) a removable top,
(b) a base, and
(c) at least three sides;
(2) at least one mesh egress point integrated into each side of the body unit;
(3) a quenching agent container, wherein the quenching agent container is containable inside the body unit;
(4) a quenching agent, wherein the quenching agent is contained inside the quenching agent container unit, and wherein the quenching agent is expellable from the quenching agent container through the mesh egress points in the body unit to quench a campfire; and
(5) an activation unit, wherein the activation unit is operably connected to expel the quenching agent from the mesh egress points when activated.

2. The device for containing a campfire according to claim 1, wherein the quenching agent is a mixture of sand and water.

3. The device for containing a campfire according to claim 1, wherein the body unit is triangular.

4. The device for containing a campfire according to claim 1, wherein the body unit has six sides.

5. The device for containing a campfire according to claim 4, wherein the body unit is twenty-five inches in height, wherein three of the six sides are four inches wide, and three of the six sides are thirty inches wide, and wherein the three four inches sides and the three thirty inches sides alternate to form a triangular shape with flat corners.

6. The device for containing a campfire according to claim 3, wherein the body unit is twenty-five inches in height and each of the three sides is thirty inches in width.

7. The device for containing a campfire according to claim 1, wherein the body unit is twenty-five inches in height and thirty inches in width.

8. The device for containing a campfire according to claim 1, wherein the top of the body unit also has a mesh egress point integrated therein.

9. A device for containing a campfire, the device comprising:
(1) a body unit having
(a) a removable top,
(b) a base,
(c) three sides that are thirty inches in width, and
(d) three sides that are four inches in width,
wherein the body unit is twenty-five inches in height, and wherein the three four inches sides and the three thirty inches sides alternate to form a triangular shape with flat corners;
(2) at least one mesh egress point integrated into each side of the body unit and at least one mesh egress point integrated into the removable top;
(3) a quenching agent container, wherein the quenching agent container is containable inside the body unit;
(4) a quenching agent comprising a mixture of sand and water, wherein the quenching agent is contained inside the quenching agent container unit, and wherein the quenching agent is expellable from the quenching agent container through the mesh egress points in the body unit to quench a campfire; and
(5) an activation unit, wherein the activation unit is operably connected to expel the quenching agent from the mesh egress points when activated.
